(19) United States
(12) Patent Application Publication
(10) Pub. No.: US 2007/0139625 A1
(43) Pub. Date: Jun. 21, 2007

(54) Method and apparatus to achieve a neutral dark state in image devices

(76) Inventor: Arthur Berman, San Jose, CA (US)

Correspondence Address: ARTHUR BERMAN, 5635 SNOWDON PLACE, SAN JOSE, CA, 95138, US

(21) Appl. No.: 11/316,100

(22) Filed: Dec. 21, 2005

(51) Int. Cl. G03B 21/14

(52) U.S. Cl. 353/84

(57) ABSTRACT

An absorptive layer is added to an image system. The absorptive layer is selected to compensate for tint in a black state of the image. The absorptive layer is inserted in an image light stream (or light chain) and then tilted or rotated to precisely tune the band [bandwidth] of the absorptive layer to produce a desired neutral dark state. In a Liquid Crystal On Silicon (LCOS) based light engine, blue wavelengths may cause a predominate tint in black portions of an image (or an entirely black image is tinted blue), and the absorptive layer is calculated to absorb an amount of blue equivalent to the tint. The absorptive layer is, for example, a yellow notch filter. The absorptive layer may also be placed in camera image chain.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention related to filters and placement of filters in a light engine. The present invention relates to the production of a neutral dark state in an imaging device. The present invention is more particularly related to the production of a neutral dark state in a Liquid Crystal on Silicon (LCOS) based video projector.

2. Discussion of Background

The components of an LCOS based video projector 100 are explained by example of a light engine with reference to FIG. 1. As shown, white light 110 is generated by a light source 105. The light is collected, homogenized, polarized, and formed into the proper shape and otherwise processed by optics (not all shown for clarity). The light then enters a prism assembly 150 where it is broken into red, green and blue polarized light beams. A set of reflective microdisplays 152A, 152B, and 152C are provided and positioned to correspond to each of the polarized light beams (the prism assembly 150 with the attached microdisplays is called a kernel). The beams then follow different paths within the prism assembly 150 such that each beam is directed to a specific reflective microdisplay. The microdisplay that interacts with (reflects) the green beam modulates the green content of a full color video image. Similarly, the red and blue contents of the full color image are modulated by corresponding “red” and “blue” microdisplays. The prism assembly 150 then recombines the modulated beams into a modulated white light beam 160 that contains the full color video image. The resultant modulated white light beam 160 then exits the prism assembly 150 and enters a projection lens 165. Finally, the image-containing beam (white light beam 160 has been modulated and now contains the full color image) is projected onto a screen 170.

The black state of the video projector 100 is produced, for example, when the microdisplays are not energized. That is, light rays reflected from each of the microdisplays are not intended to be modulated or form part of the projected image, making a black screen. Dark, but not 100% black, scenes in pictures or videos displayed on the screen 170 will likely have varying amounts or portions of a scene that are intended to be black.

### SUMMARY OF THE INVENTION

The present inventors have realized the need to improve neutrality of the dark state in image systems, and particularly in Liquid Crystal On Silicon (LCOS) projectors. In one embodiment, the present invention is a prism assembly comprising, a set of optical components configured to separate light into a set of individual light beams directed to modulating faces of the prism assembly, and an absorptive element configured to remove tint in a black state of an image in the prism assembly. The absorptive element is, for example, a yellow notch filter, or other compensating mechanism. The absorptive element is tilted (rotated) to alter the absorptive properties of the element so that the absorptive properties precisely or more closely match the dark state tint and are therefore more effective in removing the dark state tint.

In yet another embodiment, the present invention is a video projection system, comprising, a kernel configured to modulate an input light, a light engine configured to produce the input light, a lens configured to project the modulated light, and a filter, wherein the filter has properties including a physical rotation that combine to compensate for a dark state tint that would otherwise be present in the projected modulated light. In one alternative, the filter is a filter that is part of a basic design of the video projection system, but modified to compensate for the dark state tint, which may be, for example, a yellow notch filter. The video projection system is, for example, a Liquid Crystal on Silicon (LCOS) High Definition (HD) Rear Projection Television (RPTV).

Portions of both the device and method may be conveniently implemented in programming on a general purpose computer, or microprocessor or control device. The programming may include, for example steps to adjust (e.g. increase) amounts of modulation in non-dark state images or portions of images to compensate for the effects of the yellow notch filter in the non-dark state images.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of LCOS based video projector;

FIG. 2 is a drawing of a specific example of an lms-AT kernel 200;

FIG. 3 is a graph of a spectrum of a dark state projected by the lms-AT kernel 200 when utilized in a specific but representative, commercially available version of the light engine 100;

FIG. 4 is a dark state color projection based on the same data as FIG. 3 and is a 1931 C.I.E. chromaticity chart representation of the color point of the dark state;

FIG. 5 is a drawing of a light engine and kernel illustrating locations for placing a yellow filter according to several embodiments of the present invention;

FIG. 6 is a graph of a notch filter transmission versus wavelength at a normal angle of incidence according to an embodiment of the present invention;

FIG. 7 is a graph illustrating a notch filter spectra versus angle of incidence according to an embodiment of the present invention;

FIG. 8 is a graph of a notch filter center wavelength vs. angle of incidence according to an embodiment of the present invention;

FIG. 9 is a graph comparing normal filter orientation transmission and lamp output power vs. wavelength;

FIG. 10 is a drawing of a notch filter having an adjustable angle of incidence;

FIG. 11 is a graph comparing oblique filter orientation transmission and lamp output power vs. wavelength; and

FIG. 12 is a flow chart of a process of installing a filter in an image device according to embodiments of the present invention.

### DESCRIPTION OF THE PREFERRED EMBODIMENTS

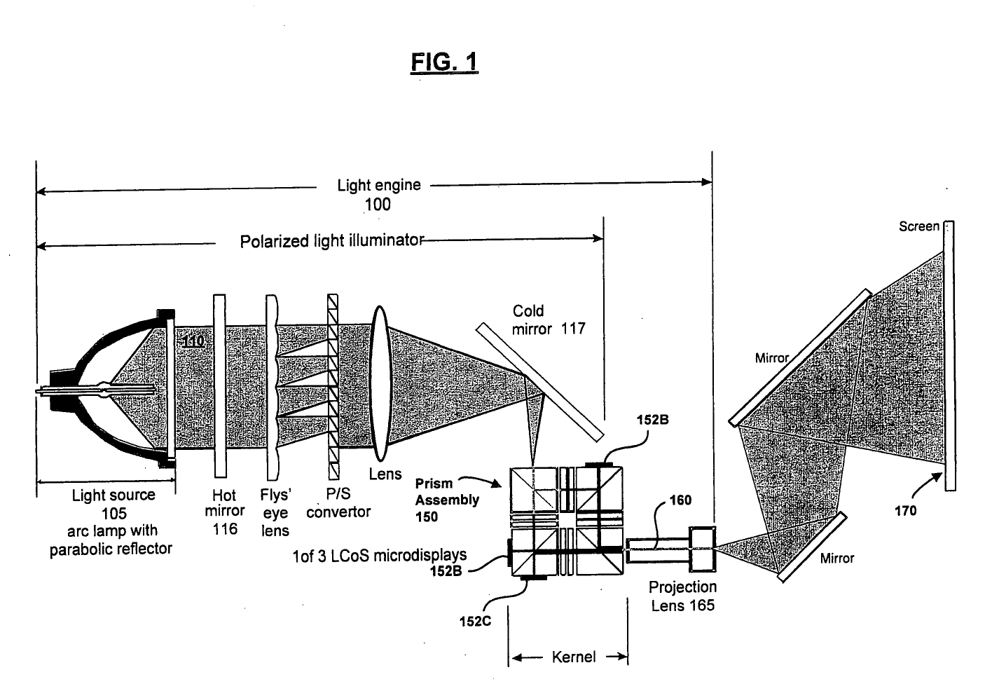

A desirable quality of a projected video image is that the dark state be a neutral black. That is, that the dark state be tinted neither red nor green nor blue. The dark state occurs in a projector, such as that described in FIG. 1, when, for example, all of the microdisplays do not modulate light and the screen displays an absence of color (black). The dark state is evident in an all black image, but the dark state may also occur in multiple locations in an otherwise non-dark state image.

The absence of color in a projected image can be hindered by certain colors or combinations of colors being reflected by the microdisplays even when the modulation is off or the microdisplays are not energized, resulting in a tint (e.g., blue tint) on the screen when displaying dark or black images or images having black or dark state portions.

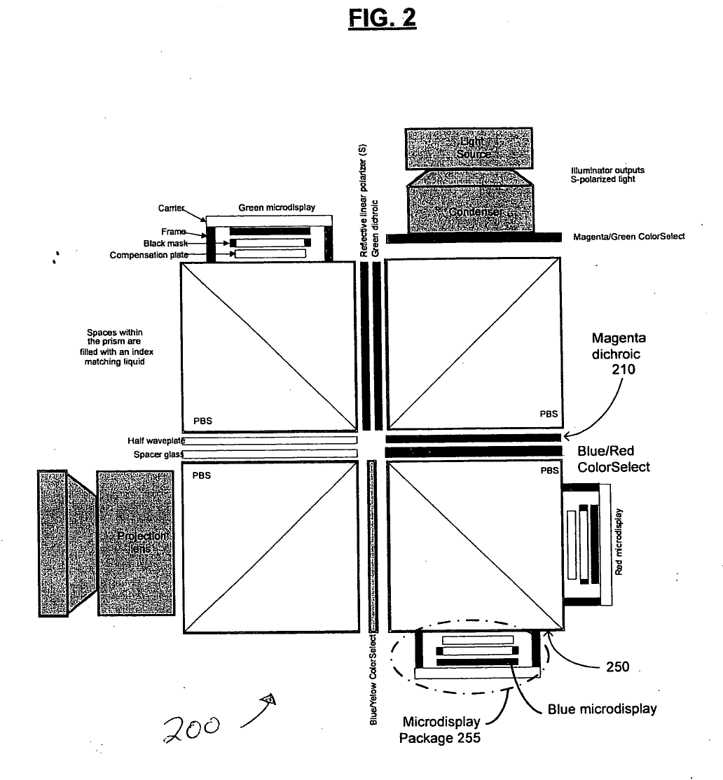

Referring again to the drawings, wherein like reference numerals designate identical or corresponding parts, and more particularly to FIG. 2 thereof, there is illustrated a specific example of a kernel 200 in which the present invention may be applied. The kernel 200 is a version of an lms-AT kernel produced by Lightmaster Systems Inc. (LMS). Optical components internal to the kernel are indicated in the figure. Although the lms-AT kernel is utilized as an example, it should be understood that kernels of other designs are readily adaptable to the present invention, and the use of the lms-AT kernel should not in any way limit application of the present invention.

More generally, the lms-AT kernel is a quad style kernel. The quad style kernel comprises a set of beam splitters, one beam splitter in each quadrant of the kernel. The lms-AT kernel utilizes a set of reflective Liquid Crystal on Silicon (LCOS) microdisplays. Each microdisplay is mounted on a processing, or modulating, face of the kernel (e.g., “red”, “blue”, and “green” microdisplays) each mounted on corresponding red, blue, and green processing faces of the kernel. Other kernel designs that are also applicable include more or less modulating faces and a corresponding number of more or less microdisplays for additional, less, and/or different colors to be modulated.

Variances in the capability of the microdisplays to modulate the different color lights contributes to the dark state of an image projected from the kernel having a tint. For example, the microdisplays are less efficient at fully “turning off” the blue beam (or light modulated by the “blue” microdisplay).

Current designs utilized by the inventor include, for example, “cube” beamsplitters that are constructed from 2 right angle triangular prisms mated at diagonals of the prisms. The triangular prisms are, for example, of unequal dimensions and positioned along the diagonals at beamsplitter pathlength matched positions (e.g., the physical pathlengths of beams split by the beamsplitter travel the same distance within the beamsplitter). The beamsplitters are placed in prism assembly pathlength matched positions in the kernel (e.g. the pathlengths of each color light beam within the kernel are the same). The prisms are glass, and liquid coupling is utilized between adjacent faces of the beamsplitters.

The glass components and liquid coupling may contribute to the overall absorption of certain wavelengths of light and either promote or hinder the provision of a balanced dark state in a projected image. The optical element disposed in the light path(s) of the present invention compensate or provide further absorption in wavelengths needed to provide the balanced dark state. That imbalance mainly being attributed to the varying modulation efficiencies of the microdisplays at the longer wavelengths of blue light, but may also be attributed to and/or contributed by other specific components of a kernel, prism assembly, projection system, and/or light engine design. Further, the present invention may be applied to image capture devices in which the imbalance may be attributed to varying capture efficiencies of different CCDs or CMOS imagers in the image capture device (e.g., video camera).

The kernel (e.g., the lms-AT version illustrated in FIG. 1), is used in a projection system, such as a video projector. The video projector may be a front video projector, or a rear projector such as the type used in a Rear Projection Television (RPTV). The qualities of the optical components and microdisplays of the kernel and an associated light engine allow the projection of High Definition (HD) quality pictures (e.g., an HD RPTV).

Thus an HD RPTV (HDTV) or HD monitor having a kernel utilizing reflective LCOS microdisplays is preferably designed in connection with a light absorbing element that removes excess blue wavelengths in a dark state of the kernel. The light absorbing element has little or no effect on non-dark state pictures because the level of modulation is increased or decreased to compensate to provide a picture or video that is properly balanced depending on the requirements of the picture to be projected. Thus, blue wavelengths removed from a non-dark state picture or video are compensated for by increasing the amount of modulation of the same blue wavelengths resulting in a picture having a proper balance according to the requirements of the picture being projected.

The present invention is also described in conjunction with the use of a specific example of a light engine normally utilized with the lms-AT kernel, and it should be equally understood that many different light engine configurations are also applicable or usable in combination with the invention. The type of light engine normally utilized with the lms-AT. kernel is shown in FIG. 1 as light engine 100.

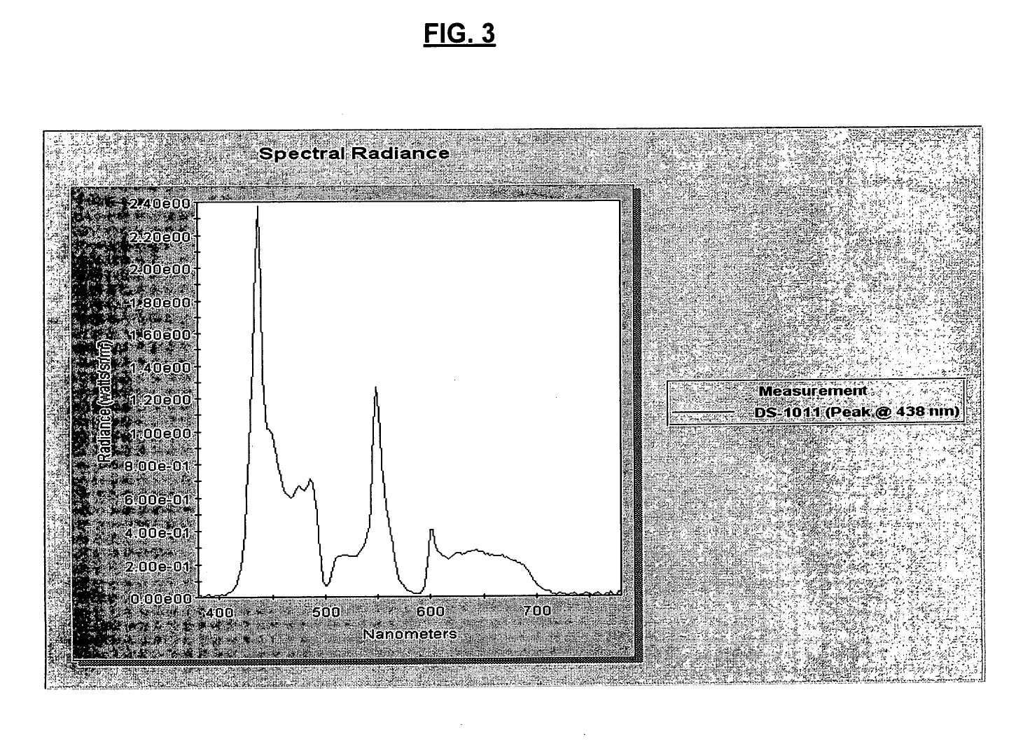

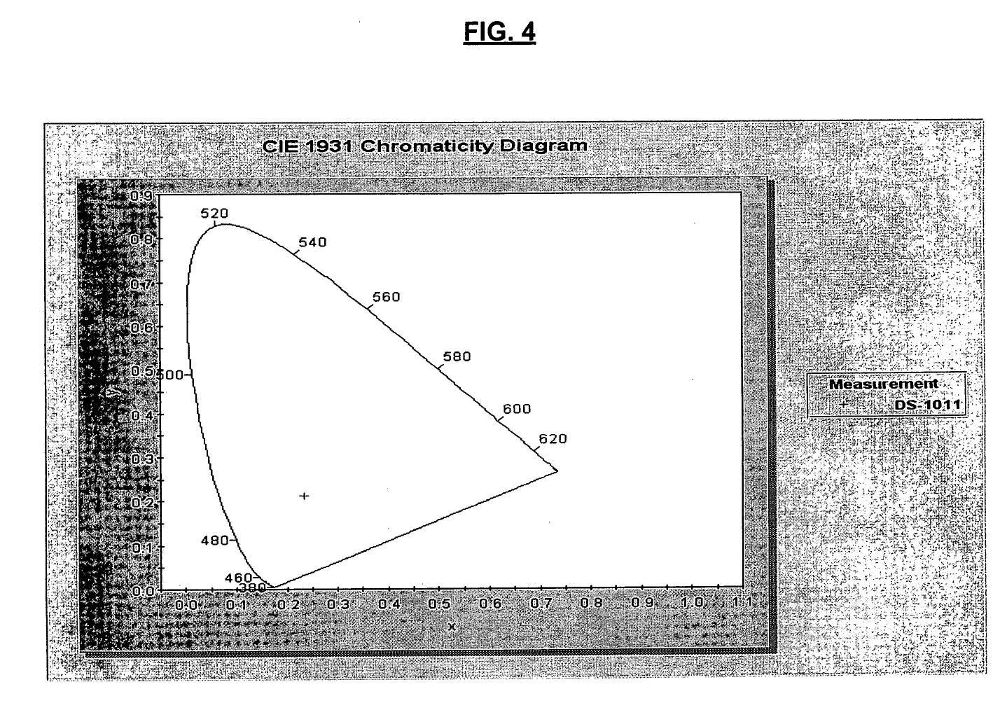

FIG. 3 is a graph of a spectrum of the dark state projected by this version of the lms-AT when utilized in a specific but representative, commercially available version of this type light engine (the type of light engine similar to light engine 100). FIG. 4 is based on the same data as in FIG. 3 and is a 1931 C.I.E. chromaticity chart representation of the color point of the dark state. The information presented in FIGS. 3 and 4 indicates that the dark state is “bluish” rather than the more desirable neutral black.

The present invention can be implemented in or adjacent to the kernel and/or other portions of the light engine or display system to make more neutral the color of the dark state projected by the light engine. The basic concept underlying the invention is that an appropriate blue absorbing element be inserted into a light path of the kernel so as to render the dark state neutral. The appropriate band and/or transmissivity of the absorbing element may then be fine tuned by tilting (rotating) the absorbing element.

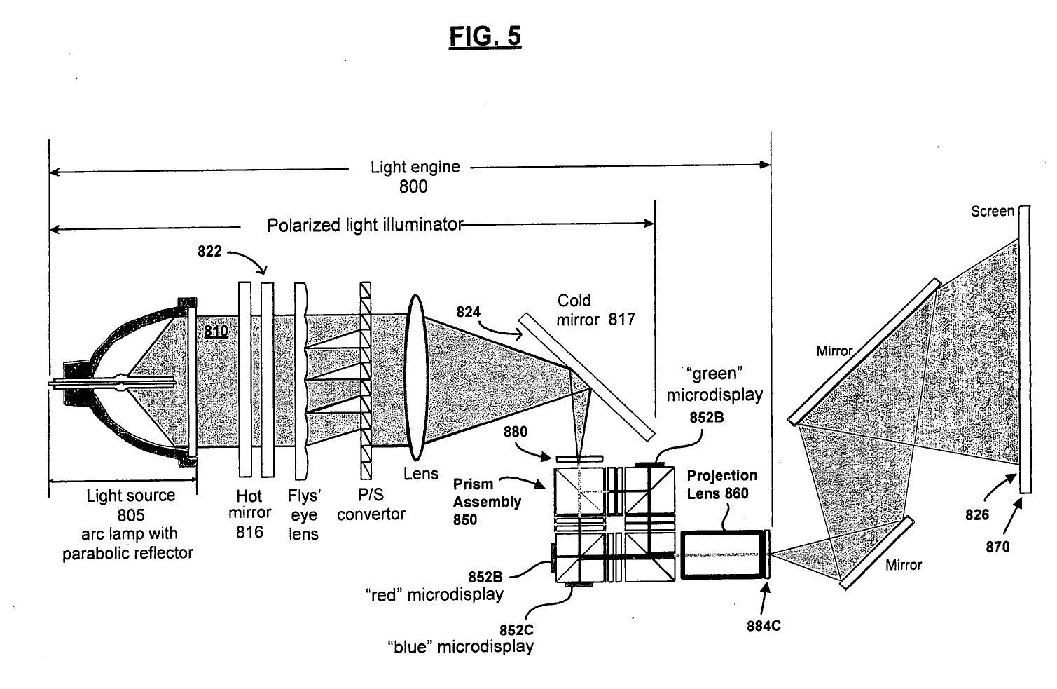

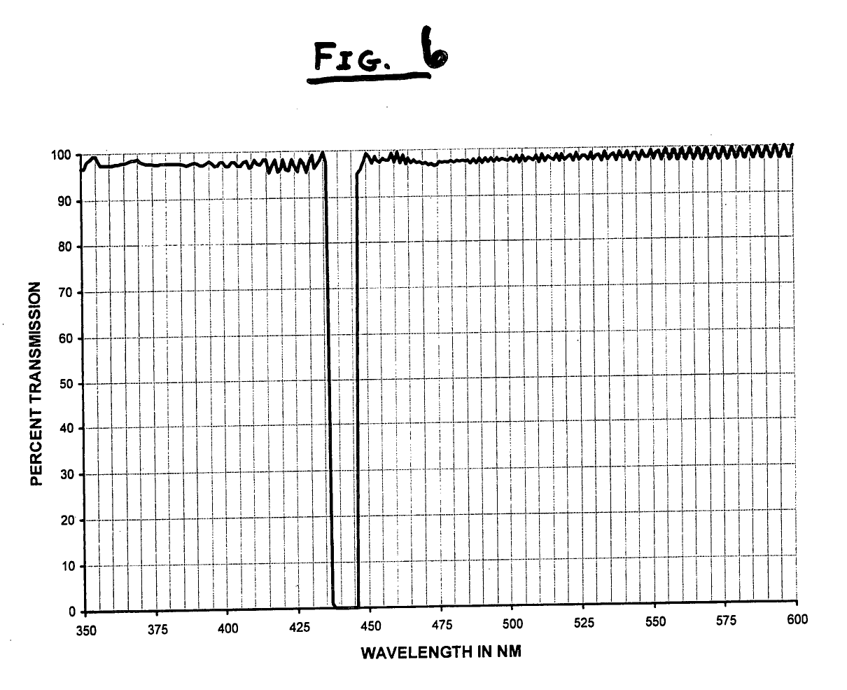

In one embodiment, pictured in FIG. 5, a yellow notch filter is inserted in optical series with the light path (light path, for example, extending from the light source 805 to display screen 870). The transmission spectrum of the type of yellow notch filter required to perform this function is illustrated in FIG. 6. The yellow notch filter can be included at any point in the optical path. Points for insertion include, for example, the input of the kernel or the output of the projection lens. Preferably, the insertion point includes just enough physical space to allow for a range of rotating to compensate for the range of dark state tints that occur due to production variances.

The basis of this embodiment of the invention is to reduce the transmission in the blue portion of the spectrum. In one embodiment, the transmission in the blue portion is reduced by the inclusion of a single dichroic thin film having the transmission characteristics illustrated in FIG. 6.

It is possible for the image projected by the subject light engine to have a dark state that deviates from neutral blackness in colors other than blue. Variations of above discussed example techniques can also be used to correct red, green or compound color deviations. In each case, the absorbing elements are selected to have properties that directly compensate for the amount(s) of red, green, or other colors and/or compound deviations of colors in which the dark state is tinted.

As shown in FIG. 5, the absorptive material (or absorptive element) (e.g., yellow absorptive material) is positioned, for example, in any one or more of a number of locations, including, but not limited to:

absorptive material 880 at an input to the kernel; and

absorptive material 884C at the projection lens output.

The present invention includes adjusting an amount of modulation of one or more microdisplays to compensate for non dark state images affected by any one or more filters or dichroics used to compensate for dark state tint. Including adjusting by increasing an amount of modulation of colors in non-dark state images displayed by the image projection system by an amount proportional to a reduction in the non-dark state images caused by the compensating filter(s). The adjusting is performed, for example, by electronics or other processing devices coupled to the microdisplays that are configured to make the appropriate modulation adjustments.

As noted above, the absorptive filter is adjustable. The absorptive filter is installed and adjusted to match as close as possible the dark state tint. The present inventor notes that this adjustment is particularly useful to accommodate the inevitable variations in dark state coloration found when video projection systems are produced in high volume.

The concept of adjusting the absorptive filter to match the dark state tint begins with the insertion of an approximately appropriate “notch filter” into the light path. The center wavelength of the notch is, for example, located in the blue portion of the spectrum. In this example, removing blue light from the light path, the dark state of the light path is rendered more neutral. An example of a notch filter spectrum is illustrated in FIG. 6. The illustrated spectrum is representative of the case when light impacts normal to the filter.

The value at the bottom of the notch illustrated in FIG. 6 is shown as close to zero transmission. In practice, the desired value would be determined by measurement and analysis of the dark state of the projected image and chosen to be appropriate to render the dark state neutral.

The notch filter can be included at any point in the optical path. The most likely locations are in the illuminator. Example locations in a light engine for the notch filter (absorptive material) are illustrated in FIG. 5. In one embodiment, the notch filter is located at an output of the projection lens (e.g. a notch filter 884C).

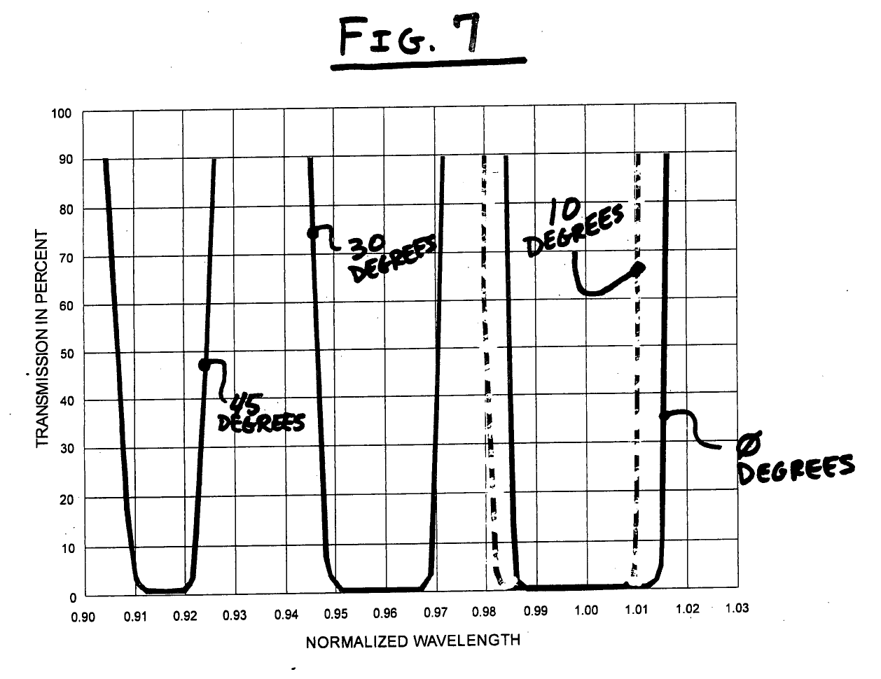

One relevant optical property of the type of the notch filter illustrated in FIG. 6 (e.g., a thin film notch filter) is that, when light impacts the filter at an off normal angle, the central wavelength of the notch shifts towards shorter wavelengths. This is illustrated in FIG. 7. and the normalized wavelength is defined as follows:

$$\overline{λ} ≡ \frac{λ}{Design Wavelength} where$$

λ=wavelength

λ̅=normalized wavelength

Note that the shift in the center wavelength can be quantified by a simple model of the normalized wavelength versus the angle of incidence as follows:
λ̅(θ)= λ̅₀\sqrt{1−(sin θ/n_{efff})²} where

λ̅₀=normalized wavelength when the angle of incidence is normal, that is 0°

θ=angle of incidence

n_{eff}=effective index of refraction

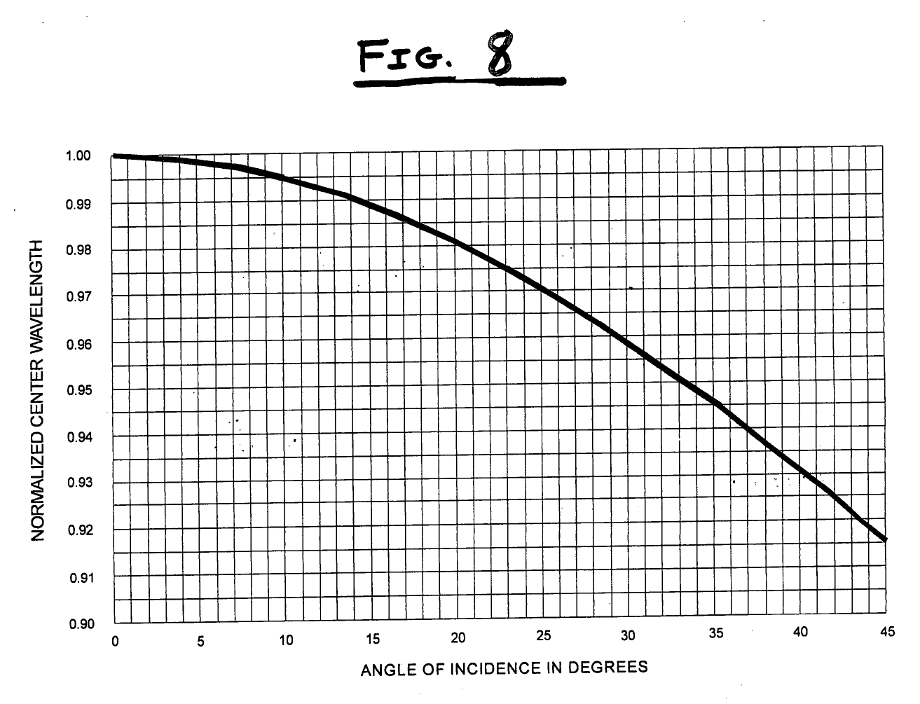

The above described relationship is graphed in FIG. 8.

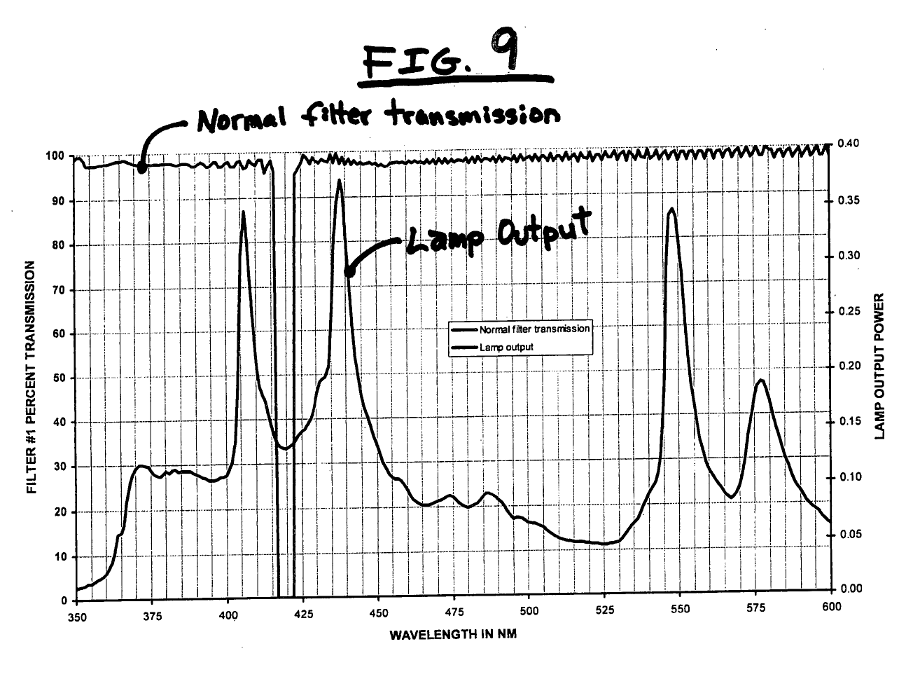

The fact that the central wavelength of the notch filter varies with angle of incidence allows for adjustment in the amount of band of blue light removed from the illumination. This in turn allows for tailoring the band size and amount of blue removal to the specific amount required to neutralize the coloration of the dark state. The concept is further explained with reference to FIGS. 9-11.

In FIG. 9, the central wavelength of the normally oriented notch filter occurs at a low intensity portion in the blue segment of the lamp power spectrum. Therefore, a correspondingly low amount of blue light is removed from the illumination and the image dark state. The result is that there is little adjustment to the coloration of the dark state.

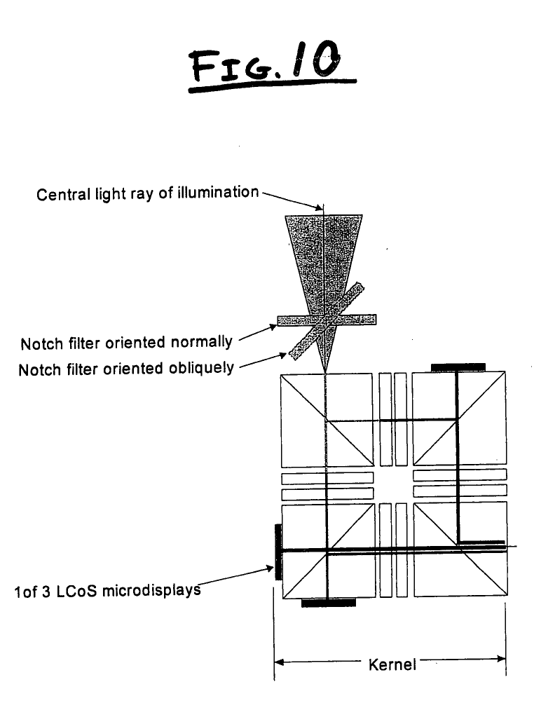

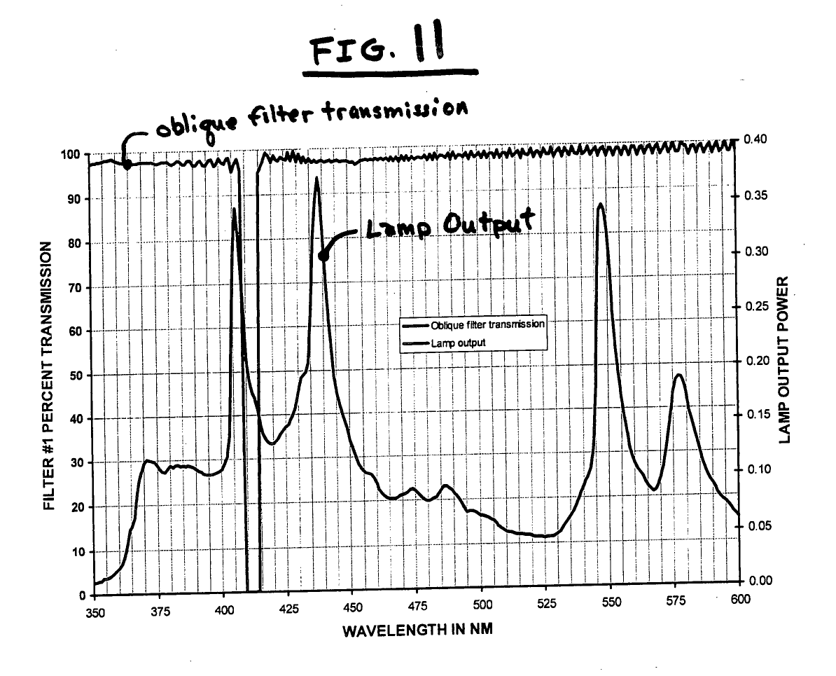

If the dark state has a greater amount of coloration then a greater amount of blue light must be removed from the illumination in order to make coloration of the dark state more neutral. To accomplish this, the angle of incidence of the notch filter is increased as diagramed in FIG. 10 (rotation of notch filter from normal incidence to and oblique angle) and the rotational effect being graphically illustrated in FIG. 11. As shown, the notch has shifted to a shorter wavelength and now coincides with a higher intensity portion of the blue segment of the lamp power spectrum. In this way, a greater amount of blue light is absorbed from the illumination and a greater correction applied to the dark state which is rendered more neutral.

The present inventor also notes that it is also possible to design the system such that the nominal orientation of the notch filter is at an angle of incidence such that the central wavelength of the notch is shifted not only to a low intensity portion of the spectrum but entirely outside the blue portion of the spectrum. In this way no blue light is removed from the illumination unless required. If required the notch filter is oriented more towards normal and the center wavelength of the notch shifts to longer, higher power intensity blue wavelengths.

The image projected by a light engine may have a dark state that deviates from neutral blackness in colors other than blue. Proper selection of the central wavelength of the notch filter will allow for correction of red, green or compound dark state coloration.

Since the output of the lamp is deficient in red, both green and blue light levels must be reduced to produce an acceptable white point. Since this is the case, filtering additional blue from the image has no effect on the brightness of the projected image. What is affected is the microdisplay gamma curve but this is not a problem. Rather, the reduction in blue is fully accommodated by the generation of a slightly different and more appropriate gamma curve during the microdisplay automatic gamma calibration process.

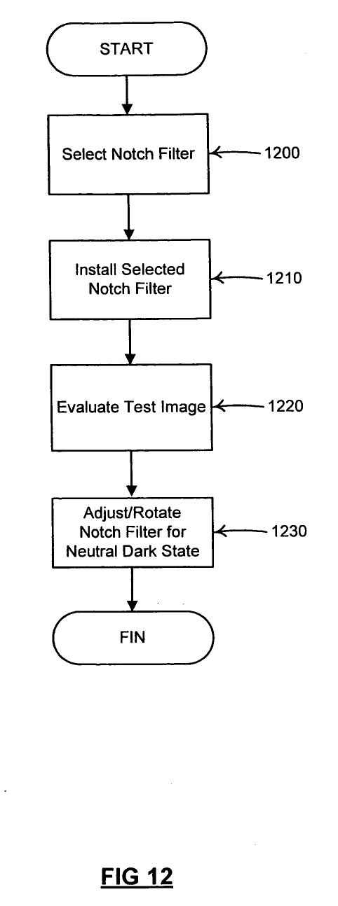

FIG. 12 is a flow chart illustrating a process of installing a notch filter according to an embodiment of the present invention. At step 1200 a notch filter is selected for inclusion in an image device.

The selected notch filter has an absorptive band that can be adjusted to produce the desired neutral dark state of the image device. The notch filter is installed (step 1210) and a test image is evaluated (step 1220).

The process continues to an adjustment step (step 1230) where the notch filter is rotated until the image device exhibits the desired neutral dark state. The notch filter is then secured (e.g., fixed to a rigid frame using an adhesive) at the rotated position.

As noted above, the above processes and use of notch filters to produce a neutral dark state are ideally implemented in video projection devices. One example being multi-channel LCOS devices such as the lms-AT kernel. Although mainly described with respect to projection devices, notch filters according to the present invention may also be installed in camera devices, particularly cameras (video or still) using multi-channel imaging chips (e.g. 3 CCDs or CMOS imagers). The notch filter is installed, for example, at any point prior to the input light impacting the imaging chips.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents, whether or not listed herein, which operate in a similar manner. Furthermore, the inventors recognize that newly developed technologies not now known may also be substituted for the described parts and still not depart from the scope of the present invention.

The present invention may suitably comprise, consist of, or consist essentially of, any of element (the various parts or features of the invention, and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A device comprising:
a set of optical components configured to separate an input light stream into a set of individual light beams directed to corresponding individual imaging devices; and
an absorptive element disposed in the input light stream and configured to remove tint in a black state of an image modulated by the prism assembly;
wherein the absorptive element is titled at an angle off normal with respect to the input light stream.

2. The prism assembly according to claim 1, wherein the absorptive element properties and the tilt angle provide an amount of absorption that precisely compensates for the tint to produce a balanced black state of an image modulated by the imaging devices.

3. The device according to claim 1, wherein the absorptive element properties and the tilt angle provide an amount of absorption that precisely compensates for the tint to produce a balanced black state of an image captured by the imaging devices.

4. The device according to claim 3, wherein the absorptive element is a yellow filter.

5. The device according to claim 4, wherein the absorptive element is located at an input of the prism assembly.

6. The prism assembly according to claim 4, wherein the absorptive element is located at an output of the set of optical components.

7. The device according to claim 4, wherein the set of optical components comprise a prism assembly in a video projection device.

8. A video projection system, comprising:
a light engine configured to produce an input light;
a kernel configured to modulate the input light;
a lens configured to project the modulated light; and
a filter set at an angle to the input light;
wherein the angle adjusts properties of the filter such that a dark state tint in the projected light is removed by the filter.

9. The video projection system according to claim 8, wherein the filter is a filter that is part of the basic design of the video projection system, but modified to compensate for the dark state tint.

10. The video projector according to claim 8, wherein the filter is a yellow notch filter.

11. The video projector according to claim 8, wherein the video projection system comprises a Rear Projection Television (RPTV).

12. The video projection system according to claim 8, wherein the video projection system is a Liquid Crystal on Silicon (LCOS) High Definition (HD) Rear Projection Television (RPTV).

13. A method, comprising the steps of:
installing a notch filter in a light stream of an image device; and
adjusting a position of the notch filter until the image device passes a test; and
fixing the adjusted position of the notch filter.

14. The method according to claim 13, wherein the notch filter has properties capable of compensating for a dark state tint of the image device.

15. The method according to claim 13, wherein the test comprises a dark state tint test.

16. The method according to claim 13, wherein the step of adjusting comprises rotating the notch filter.

17. A method, comprising the steps of:
installing a notch filter in a light stream of an image device;
rotating the notch filter relative to the light stream until a desired compensation occurs; and
fixing the notch filter at the rotated position; wherein:
the desired compensation comprises compensation of a tint in an image of the light stream; and
the notch filter comprises a yellow notch filter.

18. The method according to claim 17, wherein the tint comprises a dark state tint of the image device.

19. The method according to claim 17, wherein the tint is modulated into the light stream.

20. The method according to claim 17, wherein the image device is an image projector.

21. The method according to claim 17, wherein the image projector is a Liquid Crystal on Silicon (LCOS) High Definition (HD) Rear Projection Television (RPTV).
